(19) United States
(12) Patent Application Publication
(10) Pub. No.: US 2022/0012603 A1
(43) Pub. Date: Jan. 13, 2022

(54) ARTIFICIAL INTELLIGENCE-INITIATED PERSONALIZED SECURITY TRAINER

(71) Applicant: BANK OF AMERICA CORPORATION, Charlotte, NC (US)

(72) Inventors: Madhusudhanan Krishnamoorthy, Hasthinapuram (IN); Dhanya R., East Tambaram (IN)

(73) Assignee: BANK OF AMERICA CORPORATION, Charlotte, NC (US)

(21) Appl. No.: 16/923,303

(22) Filed: Jul. 8, 2020

(51) Int. Cl. G06N 5/04; G06N 20/00; G09B 19/00; G09B 5/02; G09B 5/06

(52) U.S. Cl. CPC G06N 5/04; G06N 20/00; G09B 5/04; G09B 5/02; G09B 5/065; G09B 19/0053

(57) ABSTRACT

An Artificial Intelligence (AI)-initiated customized/user-specific computer security training. Users' computing activity data is monitored and captured that relates to most, if not all, computing activities, functions and interactions performed by a user. A behavior model is created based on the captured computing activity data and, based on the behavior model, AI including Reinforcement Learning (RL) is implemented to determine computing activity features or patterns that define the user and computing anomalies/incidents. Multimedia security training is generated on a per-user basis based at least on the identified computing activity features/patterns and anomalies associated with a specific user.

### FIELD OF THE INVENTION

The present invention relates to a computer security, and more particularly to implementing artificial intelligence, including machine learning techniques to generate user-specific/personalized security training that takes into account the entirety of a user's computing activity to determine what training is beneficial to the user.

### BACKGROUND

A data breach is a security incident caused by unauthorized access to data being stored or transmitted in a computer environment. For most enterprises, the constant threat of data breaches is a significant concern.

Most common root causes for data breach incidents are outdated/unpatched security vulnerabilities, human error, malware, intentional insider misuse, physical misappropriation of data storing device and the like. For at least the unintentional data breaches, proper training of associates/employees (herein, referred to as “users) can mitigate and, in some instances, eliminate the occurrence of such data breach incidents and, as a result, prevent the enterprises from potential aftereffects of such data breaches; such as, loss of revenue, loss of trust, regulatory violations and the like.

The problem with current training programs is that they tend to follow a generalized approach. In other words, all of the users or groups of users are provided the same or highly similar training. Such a generalized approach does not take into account that each user is unique in terms of their computing activity. In this regard, not only are users tasked by an enterprise with performing different computing functions/activities, they also will deviate in terms of other computing functions/activities that they perform outside of the scope of their tasked functions. As such, generic training may fail to address significant security concerns that are only applicable to a small percentage of the overall user population. Additionally, generic training results in inefficiencies, in that, users may incur a loss of time by being subjected to training that is not applicable to their specific computing activities and functions. Further, when the training is generic and not targeted to the needs of the user, the user has a tendency to lose interest in the training and may choose to avoid the training altogether or fail to pay attention to the training other relevant aspects of the training.

Currently, in the event that training is required to be customized for a user or a specific group of users the customization process requires a significant amount of manual intervention, which proves to inefficient and ineffective. Moreover, any customized training that is implemented is typically a one-off occurrence and, does not take into account users are constantly performing new activities/functions that give rise to new security concerns.

Therefore, a need exists to provide users with targeted computer-related security training. In this regard, the desired targeted training should be tailored to address the specific computing activities and functions that a user performs. In addition, the desired targeted training should address specific wrongdoings or security incidents encountered by the user, so as to assure the training mitigates the likelihood of reoccurrence of such incidents. Moreover, the desired targeted training should be generated in an automated fashion that eliminates the need for manual intervention. Further, the desired targeted training should be highly adaptable to allow for changes in user activities/functions and resulting changes in associated security concerns.

### SUMMARY OF THE INVENTION

The following presents a simplified summary of one or more embodiments in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing systems, computer-implemented methods, computer program products and the like that provide for an Artificial Intelligence (AI)-initiated customized/user-specific computer security training. By providing for customized/user-specific computing security training the present invention is able to match training needs to a user's computing activity patterns and computing abnormalities, such as data breach incidents or other violations of procedures.

Embodiments of the present invention leverage the ability to monitor and capture most, if not all, computing activities, functions and interactions performed by a user. Such capturing of user actions includes both internal and external (e.g., Internet and the like) user actions. The user actions/functions may include, but are not limited to, application usage including functions/capabilities accessed and inputs provided, Internet sites/URLs accessed including inputs provided and navigation, system commands and responses, graphical control elements opened, screenshots captured, audio/video downloaded or played-back and the like.

Once a user's computing activity data has been captured, the invention provides for creating a behavior model for the user and, based on the behavior model, implementing AI, including Reinforcement Learning (RL) to determine computing activity features or patterns that define the user and detection of computing anomalies (e.g., data breach incidents and the like).

In response to determining the features or patterns that define the user and the computing anomalies, the present invention generates multimedia computer security-related training content, such as audio, video, image and/or text content that is specific to the user. In other words, the training content addresses the specific features/patterns that define the user, as well as, the computing anomalies/incidents incurred by the user.

Moreover, since the monitoring and capturing of user activity data occurs on continuous on-going basis, it is possible to continuously modify the behavior model and update/revise the features/patterns and computing abnormalities associated with the user. As result, the customized/user-specific is capable of continuously being improved to reflect and address the user's current computing features/patterns and abnormalities.

A system for generating user-specific security training defines first embodiments of the system. The system includes a first computing sub-system having a first memory and at least one first processor device in communication with the first memory. The first memory stores first computer-readable instructions that are executable by the at least first one processor device. The first computer-readable instructions are configured to monitor and capture computing activity data associated with a user.

The system additionally includes a second computing sub-system having a second memory and at least one second processor device in communication with the second memory. The second memory stores second computer-readable instructions that are executable by the at least one second processor device. The second computer-readable instructions are configured to create, using Artificial Intelligence (AI), a behavior model for the user based on the captured computing activity data. The second computer-readable instructions are further configured to determine, from the behavior model using AI, a plurality of security-related computing activity features defining the user and computing anomalies associated with the user.

Additionally, the system includes a third computing sub-system having a third memory and at least one third processor device in communication with the third memory. The third memory stores third computer-readable instructions that are executable by the at least one third processor device. The third computer-readable instructions are configured to generate, based at least on the security-related computing activity features defining the user and the computing anomalies associated with the user, multimedia security training content that is specific to the user.

In specific embodiments of the system, (i) the first computer-readable instructions configured to monitor and capture the computing activity data are further configured to continuously monitor and capture the computing activity data, (ii) the second computer-readable instructions configured to create the behavior model and determine the security-related computing activity features and computing anomalies are further configured to continuously revise the behavior model based on the continuously captured computing activity data and continuously revise the security-related computing activity features and computing anomalies and (iii) the third computer-readable instructions configured to generate the multimedia security training content are further configured to optimize, over time, based at least on the revised computing security behavior model, the multimedia security training content.

In other specific embodiments of the system, the first computer-readable instructions configured to monitor and capture the computing activity data are further configured to monitor and capture computing activity data including user activity logs associated with applications used by the user, Universal Resource Locations (URLs) accessed by the user, graphical control elements accessed and captured by the user, and multimedia content accessed by the user. In related embodiments of the system, the computing activity data further includes system command user inputs and responses, application inputs and selections, web page inputs and responses, and data security violations associated with the user.

In still further specific embodiments of the system, the second computer-readable instructions are further configured to algorithmically determine a subset of the computing activity data that most significant to computing security. In such embodiments of the system, the second computer-readable instructions may be further configured to algorithmically rank each entry in the captured computer activity data and, based on a ranking threshold, determine which of the entries are to be used to create the computing security behavior model.

Moreover, in additional specific embodiments of the system, the second computer-readable instructions configured to determine the plurality of security-related computing activity features defining the user are further configured to implement reinforcement learning, including at least one of structured Sum-of-Squares Decomposition (S3D) and Markov Decision Process (MDP), to determine the plurality of security-related computing activity features.

In further specific embodiments of the system, the third computer-readable instructions are further configured to generate the multimedia security training content are further configured to determine at least one of linguistic content and textual content based on the security-related computing activity features of the user and security commitments required of the user. In related embodiments of the system, the third computer-readable instructions are further configured to generate the multimedia security training content are further configured to determine whether pre-existing image or video files match at least one of (i) one or more of the security-related computing activity features, and (ii) one or more of the computing anomalies associated with the user. In response to determining that one or more pre-existing image or video files match at least one of (i) one or more of the security-related computing activity features, and (ii) one or more of the computing anomalies associated with the user, incorporate the one or more image or video files in the multimedia security content. In response to determining that pre-existing image or video files do not match at least one of (i) one or more of the security-related computing activity features, and (ii) one or more of the computing anomalies associated with the user, use Variational AutoEncoders (VAE) to create at least one of images or video associated with at least one of the security-related computing activity features and the computing anomalies.

A computer-implemented method for generating user-specific security training defines second embodiments of the invention. The method is executed by one or more computing processor devices. The method includes monitoring and capturing computing activity data associated with a user interfacing with one or more computing platforms. In addition, the method includes creating, using Artificial Intelligence (AI), a behavior model for the user based on the captured computing activity data and, determining, from the behavior model using AI, a plurality of security-related computing activity features defining the user and computing anomalies associated with the user. In addition, the method includes generating, based at least on the features and the computing anomalies, multimedia security training content that is specific to the user.

In specific embodiments of the computer-implemented method, (i) monitoring and capturing further comprise continuously monitor and capture the computing activity data, (ii) creating the behavior model further comprises continuously revising the behavior model based on the continuously captured computing activity data, (iii) determining the security-related computing activity features and computing anomalies further comprises continuously revising the security-related computing activity features and computing anomalies, and (iv) generating the multimedia security training content further comprises optimizing, over time, based at least on the revised computing security behavior model, the multimedia security training content.

In further specific embodiments of the computer-implemented method, monitoring and capturing the computing activity data further comprises monitoring and capturing computing activity data including (a) user activity logs associated with (i) applications used by the user, (ii) Universal Resource Locations (URLs) accessed by the user, (iii) graphical control elements accessed and captured by the user, and (iv) multimedia content accessed by the user, and (b) system command user inputs and responses, (c) application inputs and selections, (d) web page inputs and responses, and (e) data security violations associated with the user.

In other specific embodiments the computer-implemented method further includes algorithmically determining a subset of the computing activity data that most significant to computing security by ranking each entry in the captured computer activity data and, based on a ranking threshold, determine which of the entries are to be used to create the computing security behavior model.

In still further specific embodiments of the computer-implemented method, determining the plurality of security-related computing activity features defining the user further comprises implementing reinforcement learning, including at least one of structured Sum-of-Squares Decomposition (S3D) and Markov Decision Process (MDP), to determine the plurality of security-related computing activity features.

A computer program product including non-transitory computer-readable medium defines third embodiments of the invention. The computer-readable medium includes a first set of codes configured to cause a computer processor device to monitor and capture computing activity data associated with a user interfacing with one or more computing platforms. In addition, the computer-readable medium includes a second set of codes for causing a computer processor device to create, using Artificial Intelligence (AI), a behavior model for the user based on the captured computing activity data. Additionally, the computer-readable medium includes a third set of codes for causing a computer processor device to determine, from the behavior model using AI, a plurality of security-related computing activity features defining the user and computing anomalies associated with the user. Further, the computer-readable medium includes a fourth set of codes for causing a computer processing device to generate, based at least on the security-related computing activity features defining the user and the computing anomalies associated with the user, multimedia security training content that is specific to the user.

In specific embodiments of the computer program product, (i) the first set of codes are further configured to cause the computer processor device to continuously monitor and capture the computing activity data, (ii) the second set of codes are further configured to cause the computer processor device to continuously revise the behavior model based on the continuously captured computing activity data, (iii) the third set of codes are further configured to cause the computer processor device to continuously revise the security-related computing activity features and computing anomalies, and (iv) the fourth set of codes are further configured to cause the computer processor device to optimize, over time, based at least on the revised computing security behavior model, the multimedia security training content.

In additional specific embodiments of the computer program product, the first set of codes are further configured to cause the computer processor device to monitor and capture the computing activity data including (a) user activity logs associated with (i) applications used by the user, (ii) Universal Resource Locations (URLs) accessed by the user, (iii) graphical control elements accessed and captured by the user, and (iv) multimedia content accessed by the user, and (b) system command user inputs and responses, (c) application inputs and selections, (d) web page inputs and responses, and (e) data security violations associated with the user.

In other specific embodiments of the computer program product, the third set of codes is further configured to cause the computer processor device to implement reinforcement learning, including at least one of structured Sum-of-Squares Decomposition (S3D) and Markov Decision Process (MDP), to determine the plurality of security-related computing activity features.

Thus, systems, apparatus, methods, and computer program products herein described in detail below provide for an Artificial Intelligence (AI)-initiated customized/user-specific computer security training. By providing for customized/user-specific computing security training the present invention is able to match specific training needs to a user's computing activity patterns and computing abnormalities, such as data breach incidents or other violations of procedures. Further, by homing in on user specific areas of concern, the customized/user-specific computing security training of the present invention effectively decreases the time required for training.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 is a schematic diagram of a system for generating customized user-specific multimedia security training content, in accordance with embodiments of the present disclosure;

FIG. 2 is a schematic diagram of computing activity data and sources for acquiring data for behavior modelling, in accordance with embodiments of the present invention;

FIG. 3A is a block diagram of a first computing sub-system for monitoring and capturing computing activity data, in accordance with embodiments of the present invention;

FIG. 3B is a block diagram of a second computing sub-system for creating a behavior model and decisioning computing activity features/patterns and anomalies, in accordance with embodiments of the present invention;

FIG. 3C is a block diagram of a third computing sub-system generating customized user-specific multimedia computing security training content, in accordance with embodiments of the present invention.

FIG. 4 is a schematic/flow diagram of a system/method for generating customized user-specific multimedia computing security training content, in accordance with embodiments of the present invention; and

FIG. 5 is a flow diagram of a method for generating customized user-specific multimedia computing security training content, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted, or unscripted programming language such as JAVA, PERL, SMALLTALK, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Thus, embodiments of the invention provide for Artificial Intelligence (AI)-initiated customized/user-specific computer security training. By providing for customized/user-specific computing security training the present invention is able to match training needs to a user's computing activity patterns and computing abnormalities, such as data breach incidents or other violations of procedures.

Embodiments of the present invention leverage the ability to monitor and capture most, if not all, computing activities, functions and interactions performed by a user. Such capturing of user actions includes both internal and external (e.g., Internet and the like) user actions. The user actions/functions may include, but are not limited to, application usage including functions/capabilities accessed and inputs provided, Internet sites/URLs accessed including inputs provided and navigation, system commands and responses, graphical control elements opened, screenshots captured, audio/video downloaded or played-back and the like.

Once a user's computing activity data has been captured, the invention provides for creating a behavior model for the user and, based on the behavior model, implementing AI, including Reinforcement Learning (RL) to determine computing activity features or patterns that define the user and detection of computing anomalies (e.g., data breach incidents and the like).

In response to determining the features or patterns that define the user and the computing anomalies, the present invention generates multimedia computer security-related training content, such as audio, video, image and/or text content that is specific to the user. In other words, the training content addresses the specific features/patterns that define the user, as well as, the computing anomalies/incidents incurred by the user.

Moreover, since the monitoring and capturing of user activity data occurs on continuous on-going basis, it is possible to continuously modify the behavior model and update/revise the features/patterns and computing abnormalities associated with the user. As result, the customized/user-specific is capable of continuously being improved to reflect and address the user's current computing features/patterns and abnormalities.

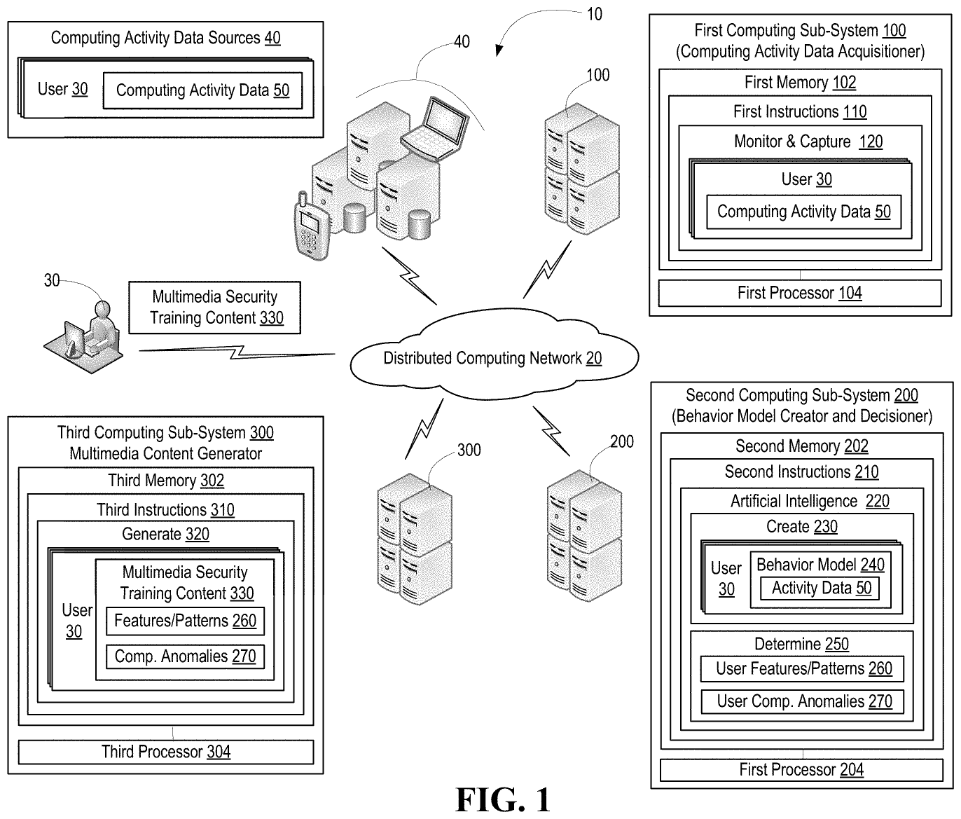

FIG. 1 illustrates a system 10 for AI-initiated customized security training, in accordance with embodiments of the present disclosure. As illustrated in FIG. 1, the system comprises three sub-systems 100, 200 and 300 that are in network communication via distributed computing network 20, which may comprise the Internet, one or more intranets and the like.

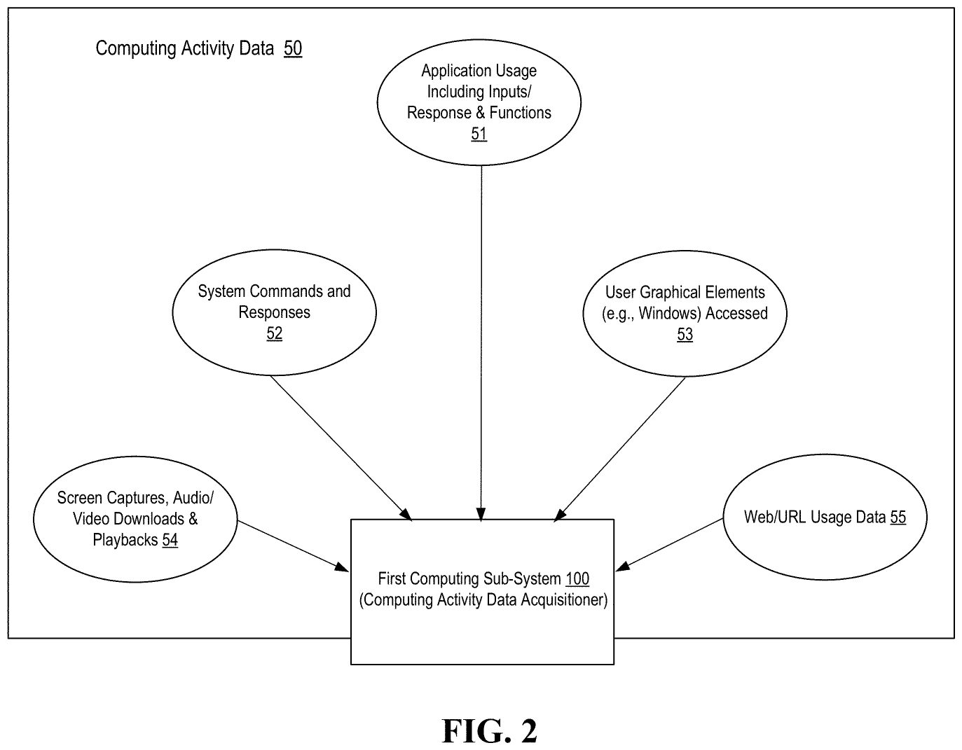

System 10 includes first computing sub-system 100, otherwise referred to as computing activity data acquisitioner sub-system. First computing sub-system 100 includes first memory 102 that is in communication with one or more first processors 104 (i.e., processor devices). First memory 102 stores first instructions 110 that are executable by first processor(s) 104. First instructions 110 are configured to monitor and capture 120, from a plurality of computing activity sources 40, computing activity data 50 for a plurality of users 30. The users 30 may comprise the associates/employees of an enterprise or the like and, specifically, associates/employees of an enterprise that requires data, which may include confidential and/or personal data, to be processed and transmitted in a highly secure manner. The computing activity data 50 may include any data related to functions, inputs or the like provided by the user interfacing with computing devices. Functions or inputs that indicate an anomaly or suspected security incident are especially of interest. The computing activity data sources 40 may be both internal and external. For example, sources 40 may be associated with internal networks (e.g., intranets), internal applications and the like, as well as external networks (e.g., Internet), external applications and the like. Examples of computing activity data 50 are shown and described in relation to FIG. 2, infra. Additionally, the computing activity data 50 may be captured from user logs or the like, while in other instances actual real-time monitoring of user functions may be required to capture relevant computing activity data 50. For purposes of insuring that the resulting customized security training content is significant to the user's security concerns, the degree to which computing activity data 50 is monitored and captured should be all inclusive.

System 10 additionally includes second computing sub-system 200, otherwise referred to as behavior model creator and decision maker sub-system. Second computing sub-system 200 includes second memory 202 that is in communication with one or more second processors 204 (i.e., processor devices). Second memory 202 stores second instructions 210 that are executable by second processor(s) 204. Second instructions 210 are configured to create 230, using Artificial Intelligence (AI), a behavior model 240 for each of the plurality of users 30 based at least on the computing activity data 50. In AI, a behavior algorithm is a software program that selects appropriate behaviors or actions for one or more intelligent agents (i.e., an autonomous entity which acts, directing its activity towards achieving goals). Examples, of behavior modelling algorithms include finite state machines, including hierarchical finite-state machines, decision trees, behavior trees, hierarchical task networks and the like. Second instructions 210 are further configured to determine 250, based at least on the behavior model and using AI, including Regression Learning (RL), user computing activity features/patterns 260 that indicate a need for security training, as well as, user computing anomalies (e.g., security incidents) that indicate a need for security training. As discussed, infra., AI including RL, such as, but not limited to structured sum-of-squares decomposition (S3D) and Markov decision process (MDP) may be used to create 230 the behavior model 240 and/or determine 250 the user computing activity features/patterns 260 and user computing anomalies 270.

System 100 additionally includes third computing sub-system 300, otherwise referred to as multimedia security training content generator sub-system. Third computing sub-system 300 includes third memory 302 that is in communication with one or more third processors 304 (i.e., processor devices). Third memory 302 stores third instructions 310 that are executable by third processor(s) 304. Second instructions 310 are configured to generate 320, for each of the plurality of users 330, customized multimedia security training content 330 based at least on the determined user computing activity features/patterns 260 and computing anomalies 270. The multimedia content may include textual, audio, image or video content. For example, the multimedia media content may include, but is not limited to, video file, an audio file, a presentation file including images and text and the like.

As described, the three sub-systems 100, 200, 300 are configured to work in unison to provide customized security training to user 30. While the illustrated embodiment of FIG. 1 provides for three sub-systems 100, 200, 300 it should be noted that more or less sub-systems may be included in the system 10. In this regard, the system 10 may comprise one comprehensive computing system (i.e., devoid of sub-systems) having a single memory component, a single processor and single instructions.

Referring to FIG. 2 a schematic diagram is presented that provides examples of computing activity data 50 that may be monitored and/or captured for purposes of behavior modelling, in accordance with embodiments of the present invention. Computing activity data 50 that is monitored and captured by first computing sub-system 100 may include, but is not limited to, application usage data 51, including applications accessed, inputs and responses provided by an application, functions performed within the application, portions/areas of the application accessed and the like. The applications may be internal applications and, where accessible to the monitoring and capturing of data, the applications may be external applications (e.g., apps executing on a mobile device or the like).

Computing activity data 50 that is monitored and captured by first computing sub-system 100 may further include system commands and responses 52 provided to a n operating system or an application. Further, computing activity data 50 that is monitored and captured by first computing sub-system 100 may further include user graphical elements (UGEs), such as windows that that are accessed within a operating system environment or the like.

Additionally, computing activity data 50 that is monitored and captured by first computing sub-system 100 may further include screen captures, audio/video downloads/playbacks 54 including attempts to download a file or otherwise access a file. The audio/video downloads may be from internal or external (i.e., Internet or the like) locations. Further, computing activity data 50 that is monitored and captured by first computing sub-system 100 may further include web usage data 55 including URLs accessed, such as websites, pages within websites, actions taken within websites, inputs provided to websites/pages, responses received and the like. Such web usage 55 may include social media usage including posting to social media sites and the like.

In specific instances the computing activity data 50 may be captured by logs associated with applications or the like that track user usage and/or functions performed within an application or the like. In other instances, in which such data may be not logged, the monitoring may include real-time monitoring of a user's computing activities and/or functions, such that as a user performs a computer-related function or activity, data associated therewith is captured by the first computing sub-system 100.

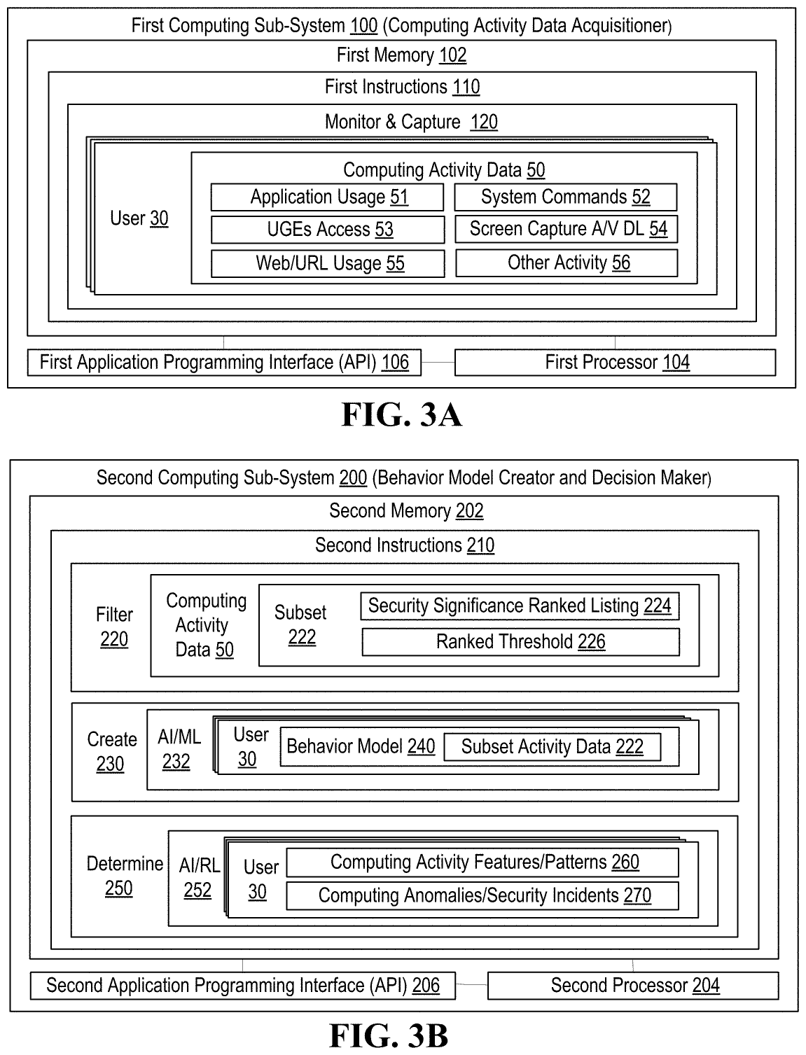

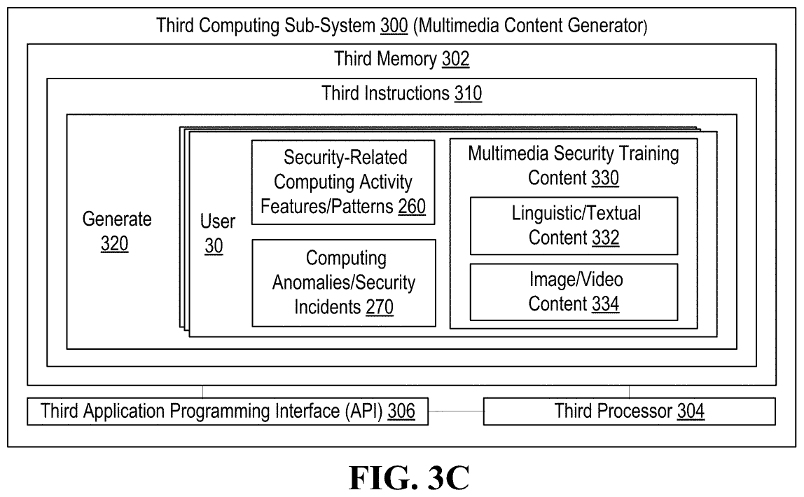

Referring to FIG. 3A depicted is first computing sub-system 100 configured for monitoring and capturing users' computing activity data, in accordance with embodiments of the present invention. In addition to providing greater detail, FIG. 3A highlights various alternative embodiments of the invention. The first computing sub-system 100 may comprise one or more computing devices (e.g., server(s) or the like) and is configured to execute engines, including instructions, algorithms, modules, routines, applications and the like. As previously noted, first computing sub-system 100 includes first memory 102 and the like which may comprise volatile and non-volatile memory, such as read-only and/or random-access memory (RAM and ROM), EPROM, EEPROM, flash cards, or any memory common to computing platforms). Moreover, first memory 102 and the like may comprise cloud storage, such as provided by a cloud storage service and/or a cloud connection service.

Further, first computing sub-system 100 also includes at least one first processor 104, otherwise referred to as a processing device or the like which may be an application-specific integrated circuit (“ASIC”), or other chipset, logic circuit, or other data processing device configured to execute first instructions 110. First processing device(s) 104 or the like may execute one or more first application programming interface (APIs) 106 that interface with any resident programs, such as first instructions 110 or the like stored in the first memory 102 of the first computing sub-system 100 and any external programs. First processing device(s) 104 may include various processing subsystems (not shown in FIG. 3A) embodied in hardware, firmware, software, and combinations thereof, that enable the functionality of first computing sub-system 100 and the operability of first computing sub-system 100 on the distributed communications network 20 (shown in FIG. 1). For example, processing subsystems allow for initiating and maintaining communications and exchanging data with other networked devices, such as first computing activity data sources 40, second computing sub-system 200 and third computing system 300 (shown in FIG. 1). For the disclosed aspects, processing subsystems of first computing sub-system 100 may include any processing subsystem used in conjunction with first instructions 110 and related engines, tools, routines, sub-routines, algorithms, sub-algorithms, sub-modules thereof.

First computing sub-system 100 may additionally include a communications module (not shown in FIG. 3A) embodied in hardware, firmware, software, and combinations thereof, that enables electronic communications between first computing sub-system 100 and other network devices, such as, but not limited to, computing activity data sources 40, second computing sub-system 200 and third computing system 300 (shown in FIG. 1). Thus, communication module may include the requisite hardware, firmware, software and/or combinations thereof for establishing and maintaining a network communication connection with one or more network devices.

First memory 102 of first computing sub-system 100 stores first instructions 110 that are executable by first processor(s) 104 and configured to monitor and capture 120 computing activity data 50 for a plurality of users 30. As previously discussed, the computing activity may be monitored and/or captured from internal data sources (i.e., sources associated with the user's place of employment or the like) or external source (e.g., websites, URLs, external applications and the like). As discussed in relation to FIG. 2, the computing activity data 50 that is monitored and captured may include, but is not limited to, internal and external application usage 51, including application access, inputs and responses, application functions used and application areas accessed. Computing activity data 50 additionally includes system commands 52 and responses to operating systems, applications and the like. In addition, computing activity data 50 includes UGEs (e.g., windows) accessed/opened or the like, screen captures, file downloads, including audio, video files downloaded and/or played-back and the like. Further, computing activity data 50 includes web/URL usage data 55 including websites/URLs accessed, website navigation, inputs provided, responses received and the like. Moreover, computing activity data 50 may include any other activity data 56 that is relevant for gaining an understanding a user's areas of concern regarding computing security training.

Referring to FIG. 3B depicted is second computing sub-system 200 configured for creating users' behavior models and decisioning users' computer activity features/patterns and anomalies, in accordance with embodiments of the present invention. In addition to providing greater detail, FIG. 3B highlights various alternative embodiments of the invention. The second computing sub-system 200 may comprise one or more computing devices (e.g., server(s) or the like) and is configured to execute engines, including instructions, algorithms, modules, routines, applications and the like. As previously noted, second computing sub-system 200 includes second memory 202 and the like which may comprise volatile and non-volatile memory, such as read-only and/or random-access memory (RAM and ROM), EPROM, EEPROM, flash cards, or any memory common to computing platforms). Moreover, second memory 202 and the like may comprise cloud storage, such as provided by a cloud storage service and/or a cloud connection service.

Further, second computing sub-system 200 also includes at least one second processor 204, otherwise referred to as a processing device or the like which may be an application-specific integrated circuit (“ASIC”), or other chipset, logic circuit, or other data processing device configured to execute second instructions 210. Second processing device(s) 204 or the like may execute one or more second application programming interface (APIs) 206 that interface with any resident programs, such as second instructions 210 or the like stored in the second memory 202 of the second computing sub-system 200 and any external programs. Second processing device(s) 204 may include various processing subsystems (not shown in FIG. 3B) embodied in hardware, firmware, software, and combinations thereof, that enable the functionality of second computing sub-system 200 and the operability of second computing sub-system 200 on the distributed communications network 20 (shown in FIG. 1). For example, processing subsystems allow for initiating and maintaining communications and exchanging data with other networked devices, such as computing activity data sources 40, first computing sub-system 100 and third computing system 300 (shown in FIG. 1). For the disclosed aspects, processing subsystems of second computing sub-system 200 may include any processing subsystem used in conjunction with second instructions 210 and related engines, tools, routines, sub-routines, algorithms, sub-algorithms, sub-modules thereof.

Second computing sub-system 200 may additionally include a communications module (not shown in FIG. 3B) embodied in hardware, firmware, software, and combinations thereof, that enables electronic communications between second computing sub-system 200 and other network devices, such as, but not limited to, computing activity data sources 40, first computing sub-system 100 and third computing system 300 (shown in FIG. 1). Thus, communication module may include the requisite hardware, firmware, software and/or combinations thereof for establishing and maintaining a network communication connection with one or more network devices.

Second memory 202 of second computing sub-system 200 stores second instructions 210 that are executable by second processor(s) 204 and configured to filter 220 the computing activity data 50 to a subset 222 thereof that is relevant for subsequent behavior modelling. In specific embodiments of the invention, second instructions 210 are configured to filter 220 the computing activity data 50 by generating a ranked listing 224 of the computing activity data in which ranking is in accordance with the most significant from a data security standpoint. In such embodiments of the invention, a ranked threshold 226 may be implemented to determine which of the computing activity datum 50 to include the behavior modelling process (i.e., only the computing activity data that is determined to have a requisite level of data security significance is included in subsequent behavior modelling).

Additionally, second instructions 210 are configured to create 230, using Artificial Intelligence (AI) including Machine Learning (ML) 232, a behavior model 240 for each of the plurality of users 30 based at least on the subset of computing activity data 222. Second instructions 210 are further configured to determine 250, based at least on the behavior model and using AI, including Regression Learning (RL) 252, user computing activity features/patterns 260 that indicate a need for security training, as well as, user computing anomalies (e.g., security incidents) that indicate a need for security training. AI including RL, such as, but not limited to structured sum-of-squares decomposition (S3D) and Markov decision process (MDP) may be used to create 230 the behavior model 240 and/or determine 250 the user computing activity features/patterns 260 and user computing anomalies 270.

MDP, which may be used as the decisioning algorithm for determining the computing activity features/patterns 260 and anomalies 270, is defined by a set of states S and actions A (both assumed to be discrete). Transition probabilities P define the probability distribution over next states given the current state and current Action (P/St+1|St, At). In MDP, transitions only depend on the current state and action. Additionally, a reward function (R: S->R) maps states to real numbers and can define rewards over state/action pairs.

Referring to FIG. 3C depicted is third computing sub-system 300 configured for generating customized user-specific multimedia computing security training content, in accordance with embodiments of the present invention. In addition to providing greater detail, FIG. 3C highlights various alternative embodiments of the invention. The third computing sub-system 300 may comprise one or more computing devices (e.g., server(s) or the like) and is configured to execute engines, including instructions, algorithms, modules, routines, applications and the like. As previously noted, third computing sub-system 300 includes third memory 302 and the like which may comprise volatile and non-volatile memory, such as read-only and/or random-access memory (RAM and ROM), EPROM, EEPROM, flash cards, or any memory common to computing platforms). Moreover, third memory 302 and the like may comprise cloud storage, such as provided by a cloud storage service and/or a cloud connection service.

Further, third computing sub-system 300 also includes at least one third processor 204, otherwise referred to as a processing device or the like which may be an application-specific integrated circuit (“ASIC”), or other chipset, logic circuit, or other data processing device configured to execute third instructions 310. Third processing device(s) 304 or the like may execute one or more third application programming interface (APIs) 306 that interface with any resident programs, such as third instructions 310 or the like stored in the third memory 302 of the third computing sub-system 300 and any external programs. Third processing device(s) 304 may include various processing subsystems (not shown in FIG. 3B) embodied in hardware, firmware, software, and combinations thereof, that enable the functionality of third computing sub-system 300 and the operability of third computing sub-system 300 on the distributed communications network 20 (shown in FIG. 1). For example, processing subsystems allow for initiating and maintaining communications and exchanging data with other networked devices, such as computing activity data sources 40, first computing sub-system 100 and second computing system 200 (shown in FIG. 1). For the disclosed aspects, processing subsystems of third computing sub-system 300 may include any processing subsystem used in conjunction with third instructions 310 and related engines, tools, routines, sub-routines, algorithms, sub-algorithms, sub-modules thereof.

Third computing sub-system 300 may additionally include a communications module (not shown in FIG. 3C) embodied in hardware, firmware, software, and combinations thereof, that enables electronic communications between third computing sub-system 300 and other network devices, such as, but not limited to, computing activity data sources 40, first computing sub-system 100 and second computing system 200 (shown in FIG. 1). Thus, communication module may include the requisite hardware, firmware, software and/or combinations thereof for establishing and maintaining a network communication connection with one or more network devices.

Third memory 302 of third computing sub-system 300 stores third instructions 310 that are executable by third processor(s) 304 and configured to generate 320, for each of the users 30, customized user-specific computing security training content 330 based at least one the security-related computing activity features/patterns 260 and the computing anomalies/security incidents 270. In specific embodiments of the invention, the multimedia security training content may include, but is not limited to, linguistic/textual content 332 and image/video content 334.

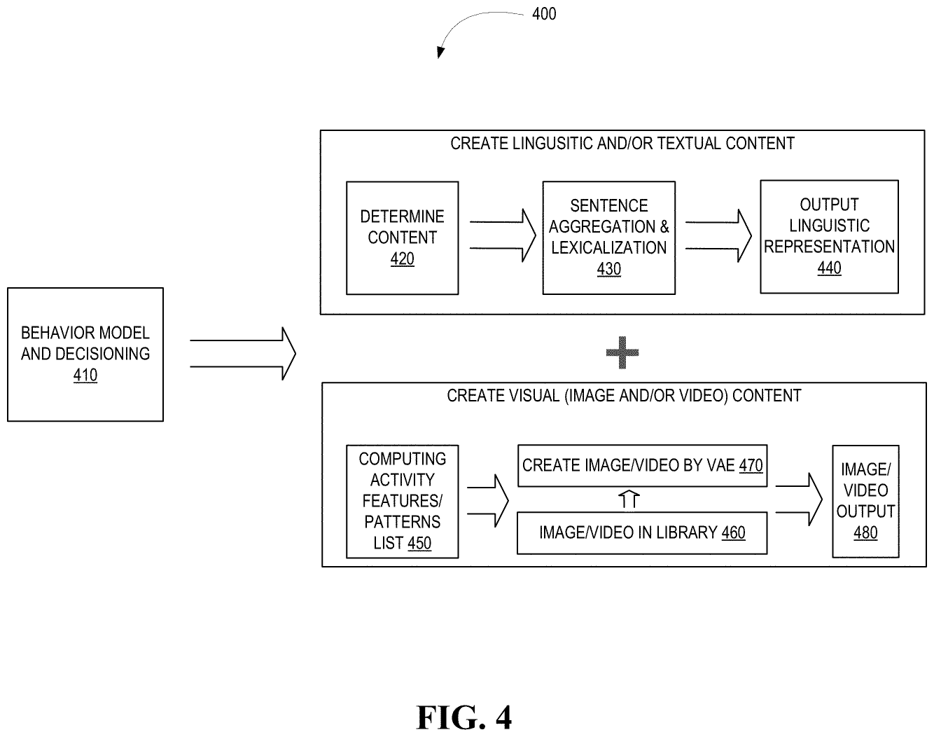

Referring to FIG. 4 is schematic/flow diagram is presented of a method for generating customized user-specific computing security training content, in accordance with embodiments of the present invention. The input 410 for generation of the computing security training content is the behavior model and, specifically, the decisioning derived therefrom, i.e., the computing activity features/patterns and computing anomalies. Linguistic and/or textual content is created by determining the linguistic/textual content 420 based on the computing activity features/patterns and computing anomalies. Once the content is determined, sentence aggregation and lexicalization 430 occurs. The output 440 is a linguistic representation, such as text, content that can be used to form an audio file or the like.

In addition to linguistic and/or textual content, visual (i.e., image or video) content is created. An activity features/patterns list 450 is algorithmically determined. A determination is made as to whether features/patterns in the list match images and/or videos in an existing image/video library 460. If features/patterns in the list 450 are determined to match existing images/videos in the library 450, they are used to assemble the image/video output content 480. If features/patterns in the list do not match existing images/videos in the library 460, image/video content is created 470. In specific embodiments of the invention the image/video content is created by a neural network, such as conditional Variation AutoEncoders (VAE) or the like. In response to outputted 480 the image/video content, the image video content is combined with the linguistic/textual content to create the user-specific multimedia computing security training content.

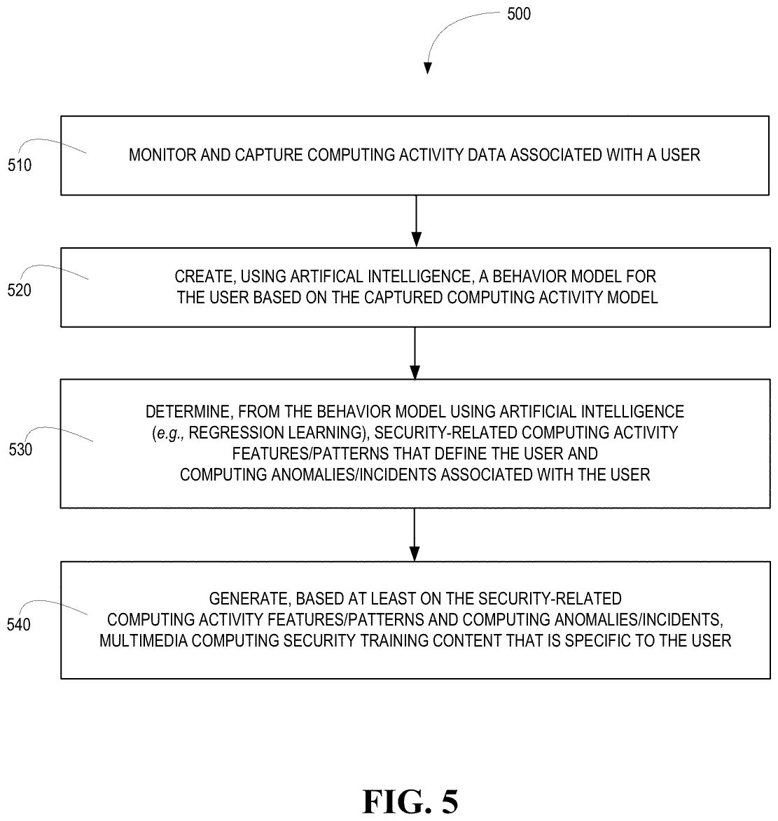

Referring to FIG. 5 a flow diagram is depicted of a method for creating user-specific computing security training content, in accordance with embodiments of the present invention. At Event 510, computer activity data is monitored and captured for a user from a plurality of sources. The user may comprise an associate/employee of an enterprise or the like. The computing activity data may include any data related to functions, inputs or the like provided by the user interfacing with computing devices, including functions or inputs that indicate an anomaly or suspected security incident. The sources may be both internal and external. For example, sources may be associated with internal networks (e.g., intranets), internal applications and the like, as well as external networks (e.g., Internet), external applications and the like. The computing activity data may be captured from user logs or the like, while in other instances actual real-time monitoring of user functions may be required to capture relevant computing activity data.

At Event 520, implementing AI including in some embodiments ML, a behavior model is created for the user based at least on a portion of the computing activity data. As previously discussed, in specific embodiments of the invention, the computer activity data is filtered prior to creating the behavior model as a means of insuring that only the most significant data associated with computing security is used to form the behavior model. At Event 539, a decisioning process determines, based at least on the behavior model and using AI, including Regression Learning (RL), user computing activity features/patterns that indicate a need for security training, as well as, user computing anomalies (e.g., known or possible security incidents) that indicate a need for security training. In specific embodiments of the method, RL in the form of Markov Decision Process (MDP) is implemented to determine the user computing activity features/patterns and user computing anomalies.

At Event 540, customized user-specific multimedia security training content is generated for the user based at least on the determined user computing activity features/patterns and computing anomalies 270. The multimedia content may include textual, audio, image or video content. For example, the multimedia media content may include, but is not limited to, video file, an audio file, a presentation file including images and text and the like.

As evident from the preceding description, the systems, methods and the like described herein represents an improvement in technology, specifically, embodiments of the present invention provide for provide for an Artificial Intelligence (AI)-initiated customized/user-specific computer security training. By providing for customized/user-specific computing security training the present invention is able to match specific training needs to a user's computing activity patterns and computing abnormalities, such as data breach incidents or other violations of procedures. Further, by homing in on user specific areas of concern, the customized/user-specific computing security training of the present invention effectively decreases the time required for training.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for generating user-specific security training, the system comprising:
a first computing sub-system including a first memory and at least one first processor device in communication with the first memory, wherein the first memory stores first computer-readable instructions that are executable by the at least first one processor device and are configured to monitor and capture computing activity data associated with a user interfacing with one or more computing platforms;
a second computing sub-system including a second memory and at least one second processor device in communication with the second memory, wherein the second memory stores second computer-readable instructions that are executable by the at least one second processor device and are configured to create, using Artificial Intelligence (AI), a behavior model for the user based on the captured computing activity data and determine, from the behavior model using AI, a plurality of security-related computing activity features defining the user and computing anomalies associated with the user; and
a third computing sub-system including a third memory and at least one third processor device in communication with the third memory, wherein the third memory stores third computer-readable instructions that are executable by the at least one third processor device and are configured to generate, based at least on the security-related computing activity features defining the user and the computing anomalies associated with the user, multimedia security training content that is specific to the user.

2. The system of claim 1, wherein (i) the first computer-readable instructions configured to monitor and capture the computing activity data are further configured to continuously monitor and capture the computing activity data, (ii) the second computer-readable instructions configured to create the behavior model and determine the security-related computing activity features and computing anomalies are further configured to continuously revise the behavior model based on the continuously captured computing activity data and continuously revise the security-related computing activity features and computing anomalies and (iii) the third computer-readable instructions configured to generate the multimedia security training content are further configured to optimize, over time, based at least on the revised computing security behavior model, the multimedia security training content.

3. The system of claim 1, wherein the first computer-readable instructions configured to monitor and capture the computing activity data are further configured to monitor and capture computing activity data including user activity logs associated with applications used by the user, Universal Resource Locations (URLs) accessed by the user, graphical control elements accessed and captured by the user, and multimedia content accessed by the user.

4. The system of claim 1, wherein the first computer-readable instructions configured to monitor and capture the computing activity data are further configured to monitor and capture computing activity data including system command user inputs and responses, application inputs and selections, web page inputs and responses.

5. The system of claim 1, wherein the first computer-readable instructions configured to monitor and capture the computing activity data are further configured to monitor and capture computing activity data including data security violations associated with the user.

6. The system of claim 1, wherein the second computer-readable instructions are further configured to algorithmically determine a subset of the computing activity data that most significant to computing security.

7. The system of claim 6, wherein the second computer-readable instructions configured to algorithmically determine a subset of the computing activity data that most significant to computing security are further configured to algorithmically rank each entry in the captured computer activity data and, based on a ranking threshold, determine which of the entries are to be used to create the computing security behavior model.

8. The system of claim 1, wherein the second computer-readable instructions configured to determine the plurality of security-related computing activity features defining the user are further configured to implement reinforcement learning, including at least one of structured Sum-of-Squares Decomposition (S3D) and Markov Decision Process (MDP), to determine the plurality of security-related computing activity features.

9. The system of claim 1, wherein the third computer-readable instructions are further configured to generate the multimedia security training content are further configured to determine at least one of linguistic content and textual content based on the security-related computing activity features of the user and security commitments required of the user.

10. The system of claim 1, wherein the third computer-readable instructions are further configured to generate the multimedia security training content are further configured to determine whether pre-existing image or video files match at least one of (i) one or more of the security-related computing activity features, and (ii) one or more of the computing anomalies associated with the user and, in response to determining that one or more pre-existing image or video files match at least one of (i) one or more of the security-related computing activity features, and (ii) one or more of the computing anomalies associated with the user, incorporate the one or more image or video files in the multimedia security content.

11. The system of claim 1, wherein the third computer-readable instructions are further configured to determine whether pre-existing image or video files match at least one of (i) one or more of the security-related computing activity features, and (ii) one or more of the computing anomalies associated with the user are further configured to, in response to determining that pre-existing image or video files do not match at least one of (i) one or more of the security-related computing activity features, and (ii) one or more of the computing anomalies associated with the user, use Variational AutoEncoders (VAE) to create at least one of images or video associated with at least one of the security-related computing activity features and the computing anomalies.

12. A computer-implemented method for generating user-specific security training, the method executed by one or more computing processor devices and comprising:
monitoring and capturing computing activity data associated with a user;
creating, using Artificial Intelligence (AI), a behavior model for the user based on the captured computing activity data;
determining, from the behavior model using AI, a plurality of security-related computing activity features defining the user and computing anomalies associated with the user; and
generating, based at least on the security-related computing activity features defining the user and the computing anomalies associated with the user, multimedia security training content that is specific to the user.

13. The computer-implemented method of claim 12, wherein (i) monitoring and capturing further comprise continuously monitor and capture the computing activity data, (ii) creating the behavior model further comprises continuously revising the behavior model based on the continuously captured computing activity data, (iii) determining the security-related computing activity features and computing anomalies further comprises continuously revising the security-related computing activity features and computing anomalies, and (iv) generating the multimedia security training content further comprises optimizing, over time, based at least on the revised computing security behavior model, the multimedia security training content.

14. The computer-implemented method of claim 12, wherein monitoring and capturing the computing activity data further comprises monitoring and capturing computing activity data including (a) user activity logs associated with (i) applications used by the user, (ii) Universal Resource Locations (URLs) accessed by the user, (iii) graphical control elements accessed and captured by the user, and (iv) multimedia content accessed by the user, and (b) system command user inputs and responses, (c) application inputs and selections, (d) web page inputs and responses, and (e) data security violations associated with the user.

15. The computer-implemented method of claim 12, further comprising algorithmically determining a subset of the computing activity data that most significant to computing security by ranking each entry in the captured computer activity data and, based on a ranking threshold, determine which of the entries are to be used to create the computing security behavior model.

16. The computer-implemented method of claim 12, wherein determining the plurality of security-related computing activity features defining the user further comprises implementing reinforcement learning, including at least one of structured Sum-of-Squares Decomposition (S3D) and Markov Decision Process (MDP), to determine the plurality of security-related computing activity features.

17. A computer program product including non-transitory computer-readable medium that comprises:
a first set of codes configured to cause a computer processor device to monitor and capture computing activity data associated with a user interfacing;
a second set of codes for causing a computer processor device to create, using Artificial Intelligence (AI), a behavior model for the user based on the captured computing activity data;
a third set of codes for causing a computer processor device to determine, from the behavior model using AI, a plurality of security-related computing activity features defining the user and computing anomalies associated with the user; and
a fourth set of codes for causing a computer processing device to generate, based at least on the security-related computing activity features defining the user and the computing anomalies associated with the user, multimedia security training content that is specific to the user.

18. The computer program product of claim 17, wherein (i) the first set of codes are further configured to cause the computer processor device to continuously monitor and capture the computing activity data, (ii) the second set of codes are further configured to cause the computer processor device to continuously revise the behavior model based on the continuously captured computing activity data, (iii) the third set of codes are further configured to cause the computer processor device to continuously revise the security-related computing activity features and computing anomalies, and (iv) the fourth set of codes are further configured to cause the computer processor device to optimize, over time, based at least on the revised computing security behavior model, the multimedia security training content.

19. The computer program product of claim 17, wherein the first set of codes are further configured to cause the computer processor device to monitor and capture the computing activity data including (a) user activity logs associated with (i) applications used by the user, (ii) Universal Resource Locations (URLs) accessed by the user, (iii) graphical control elements accessed and captured by the user, and (iv) multimedia content accessed by the user, and (b) system command user inputs and responses, (c) application inputs and selections, (d) web page inputs and responses, and (e) data security violations associated with the user.

20. The computer program product of claim 17, wherein the third set of codes is further configured to cause the computer processor device to implement reinforcement learning, including at least one of structured Sum-of-Squares Decomposition (S3D) and Markov Decision Process (MDP), to determine the plurality of security-related computing activity features.
